(19) United States
(12) Patent Application Publication
(10) Pub. No.: US 2001/0039540 A1
(43) Pub. Date: Nov. 8, 2001

(54) Method and structure for dynamic conversion of data

(76) Inventors: Ralf Hofmann, Hamburg (DE); Michael Honnig, Hamburg (DE)

Correspondence Address: Forrest Gunnison, GUNNISON, McKAY & HODGSON, L.L.P., GARDEN WEST OFFICE PLAZA, SUITE 220, 1900 GARDEN ROAD, MONTEREY, CA, 93940, US

(21) Appl. No.: 09/759,742

(22) Filed: Jan. 12, 2001

(30) Foreign Application Priority Data
Jan. 14, 2000 (EP) 00100211.2

(51) Int. Cl. G06F 17/30

(52) U.S. Cl. 707/3; 707/101

(57) ABSTRACT

A filter server receives a request for data, and in responses retrieves a rule set for a plurality of partial filter adapters from a filter registry. A filter is built using said rule set. The filter includes a chain of said plurality of partial filter adapters. Each partial filter adapter includes a generic format independent interface. The generic format independent interface is used in passing data from one partial filter adapter in said plurality of partial filter adapters to another partial filter adapter in said plurality of partial filter adapters.

### BACKGROUND OF THE INVENTION

1. Field of the Invention

The present invention relates generally to data format conversion, and in particular to a method for dynamically converting data having a first data format into data having another data format or alternatively rendering the same data in different ways.

2. Description of Related Art

Data is understood to be arrangements of information to be processed by a computer system. The arrangement of information is made in a certain data format. Each data format corresponds to a specific software module or groups of software modules, which support the respective data format. Examples of data formats include the ASCII format and the HTML-format, both being able to be processed by a group of text processing software modules, or the doc-format or the sdw-format, destined to be processed by a specific text processing software module.

Data may be stored on a storage medium, for example, a hard disc, a soft disc or a CD-ROM. If data having a certain data format is retrieved by a user, the user must have access to a computer system utilizing a software module, which supports the data format of this data. In global business, the number of situations grows where a user wants to access data being stored somewhere in a first data format from a computer system supporting data formats that do not include this first data format, or from a computer system with limited capabilities, e.g., no fonts, speech only, that will not permit viewing all the information.

In the prior art, format conversion programs are known which allow the conversion of data from one specific data format to another specific data format. See for example International Publication Number WO 98/53393 entitled “Data Stream Processing on Networked Computer System Lacking Format-Specific Data Processing Resources” of T. V. Raman dated Nov. 26, 1998. However, each data conversion from one specific data format to another specific data format requires a separate converter or in the terms of the cited publication, a parsing server.

This means that a user who wants to be able to read data existing in a certain data format on computer systems supporting other data formats has to make sure that access is provided to a substantial number of converting programs when required. Although, many converting programs are meanwhile available via the Internet at no or low cost, it is nevertheless cumbersome to access these programs when needed. Also, most of these conversion programs are available only for desktop systems, and their executables are dependent upon a specific hardware architecture and/or operating system. Such conversion programs cannot be used on devices like mobile phones or hand-held personal digital assistants.

One solution to this problem was to provide a capability to translate a first data format into an intermediate data format, and then another capability to translate the intermediate data format into a second data format. An example of this approach includes International Publication Number WO 96/37817, entitled “System and Method for Converting Data From a First Data Format to a Second Data Format,” of J. Todd Coleman, published on Nov. 28, 1996. However, this system is not useable by someone that does not have computer coding experience. It requires input of a series of commands that define the data in detail. In particular, according to Coleman “The user enters a plurality of commands referred to as MapTo commands, and these commands specify the mappings between fields or parts of tables.”

This use of a conversion to and from an intermediate data format reduces the total number of converting programs required. However, conversion between two data formats that requires the complexity disclosed by Coleman is not useful to the average computer user. In general, conversion of every data format into and from only one intermediate format is undesirable. The one intermediate format cannot include all the information required to properly present the data for every desired input or output format. Consequently, the quality of the data conversions is limited by the functionality of the one intermediate format.

### SUMMARY OF THE INVENTION

According to one embodiment of the present invention, a user transparently accesses data having a format that is different from formats supported by the user's device. In another embodiment, a first computer system transparently transcodes data supplied to a second computer system without user intervention. In yet another embodiment, a user request access to data, but the user is authorized to access only a portion of the source data. Again transparently to the user, the source data is rendered into data for which the user is authorized, i.e., the same data is rendered in a different way. In each of these embodiments, a filter server generates a filter that performs the required task.

In one embodiment, when a filter server receives a request for data, a rule set for a plurality of partial filter adapters is retrieved using a filter registry. A filter is built using the rule set. The filter includes a chain of the plurality of partial filter adapters. Each partial filter adapter includes a generic format independent interface. The generic format independent interface is used in passing data from one partial filter adapter in the plurality of partial filter adapters to another partial filter adapter in the plurality of partial filter adapters.

In the first embodiment described above, the filter that is constructed converts the data into a format that can be processed on the user's device. In the second embodiment, the constructed filter is used, for example, to substitute information in one document with other information. In the third embodiment, the constructed filter is used to remove data for which the user is not authorized, i.e., the filter renders the source data in a different way to produce the data accessed by the user.

In one embodiment, the generic format independent interface is an event-driven interface. One embodiment of the event-driven interface is a Simple API for XML interface.

In still another embodiment, the partial filter adapters comprise a general partial filter adapter having functionality determined by a parameter. For example, the general partial filter adapter comprises an extensible Style sheet Language Transformation processor, and the parameter comprises an extensible Style sheet Language Transformation script.

A computer program product, in one embodiment, comprises a medium configured to store or transport computer readable code for a method comprising:

receiving a request for data;

retrieving, from a filter registry in response to the request, a rule set for a plurality of partial filter adapters wherein, upon being chained together the plurality of partial filter adapters converts source data to the data; and

building a filter using the rule set wherein the filter comprises a chain of the plurality of partial filter adapters wherein each partial filter adapter includes a generic format independent interface and the generic format independent interface is used in passing data from one partial filter adapter in the plurality of partial filter adapters to another partial filter adapter in the plurality of partial filter adapters.

A structure, in one embodiment of the present invention includes a partial filter adapter library, and a partial filter adapter registry. The partial filter adapter registry includes a rule set. A filter server is coupled to the partial filter adapter registry and to the partial filter adapter library. The filter server uses the rule set to build a filter using a plurality of partial filter adapters from the partial filter adapter library. Thus, the filter server generates a structure including a first partial filter adapter having a generic format independent interface, and a second partial filter adapter having the generic format independent interface coupled to the first partial filter adapter.

### BRIEF DESCRIPTION OF THE DRAWINGS

FIG. 1A is a high level diagram of a computer network system that includes one embodiment of the filter server of the present invention.

FIG. 1B is a high level diagram of a computer system that includes one embodiment of the filter server of the present invention.

FIG. 2 is a block diagram of a filter built according to one embodiment of the present invention.

FIG. 3 is a block diagram of one embodiment of the filter server of the present invention.

FIG. 4 is a process flow diagram of one embodiment of processing a data conversion request by the filter server of FIG. 3.

FIG. 5 is a process flow diagram of one embodiment for using the dynamic data conversion process of the present invention.

FIGS. 6A to 6C are three embodiments of filters generated using a plurality of partial filter adapters with a generic format independent interface for passing data from one partial filter adapter to the next partial filter adapter.

FIG. 7A is a first embodiment of a use for a filter constructed using the filter server of FIG. 3.

FIG. 7B is a second embodiment of a use for a filter constructed using the filter server of FIG. 3.

FIG. 7C is a third embodiment of a use for a filter constructed using the filter server of FIG. 3.

FIG. 7D is a fourth embodiment of a use for a filter constructed using the filter server of FIG. 3.

In the Figures and the following Detailed Description, elements with the same reference numeral are the same element or similar elements. Also, the first digit of a reference numeral for an element indicates the figure in which that element first appeared. Herein, italics are used only to aid in reading the disclosure. A word in italics and the same word not in italics represent the same thing and are the same word.

### DETAILED DESCRIPTION

According to one embodiment of the present invention, a user can access the user's data or other data of interest to and available to the user from any one of a plurality of user devices 102A to 102F. When a first computer program executing on a user device, e.g., device 102A, issues a request for data, in response to a user input, the request is received by a second computer program, e.g., web server 111, executing on another computer system, e.g., server system 100.

If the requested data has a format that can be processed by the first computer program, second computer program 111 simply retrieves the requested data and sends that data to user device 102A. However, if the requested data has a format that cannot be processed by the first computer program, second computer program 111 passes the data request to a filter server 120 of this invention.

In one embodiment, as explained more completely below, filter server 120 determines data formats that can be processed by the first computer program. Filter server 120 also determines the data format of the requested data. Using the two data formats, filter server 120 dynamically creates a data filter that in turn converts the format of the requested data to one of the formats that can be processed by the first computer program.

With filter server 120, the user is no longer restricted to retrieving data on user devices that support the same application that was originally used to store the data. Moreover, the user is unaware that filter server 120 is utilized, because filter server 120 is automatically called when the services of filter server 120 are required. Consequently, filter server 120 eliminates prior art limitations on accessing data from a wide variety of user devices.

Filter server 120 is used not only to convert documents based upon a request from a user device, but also to convert documents in response to a request from another computer system without user interaction. For example, in a business-to-business environment, filter server 120 is used to transcode data, which changes the data while the data is being processed. For example, a filter supplied by filter server 120 is used to substitute part numbers in one document with the required order numbers for the supplier.

In still another application, filter server 120 does not convert a document from a source data format to a target data format, but rather allows the rendering of the same data in different ways. For example, a user, who is not authorized to view a complete spreadsheet, sees only a particular set of rows of the spreadsheet when the complete spreadsheet is processed with a filter supplied by filter server 120.

For example, in one embodiment, a user may store an address-list as a part of a schedule program via a workstation 102C connected to enterprise network 103. The address-list for the schedule program is stored in user documents on a storage device 113 of server system 100 that also is connected to enterprise network 103. The source format of the stored address-list is determined by the schedule program.

While visiting a friend, the user wants to access the address-list, but the friend has only a home personal computer (PC) 102D available, which uses a different operating system and a different suite of programs than those available to the user via workstation 102C. Nevertheless, the user is able to access the stored address-list by using a browser, the first computer program referred to above, executing on the friend's home personal computer 102D. Via an Internet service provider, the user contacts server system 100 and requests the address-list using the browser on personal computer 102D.

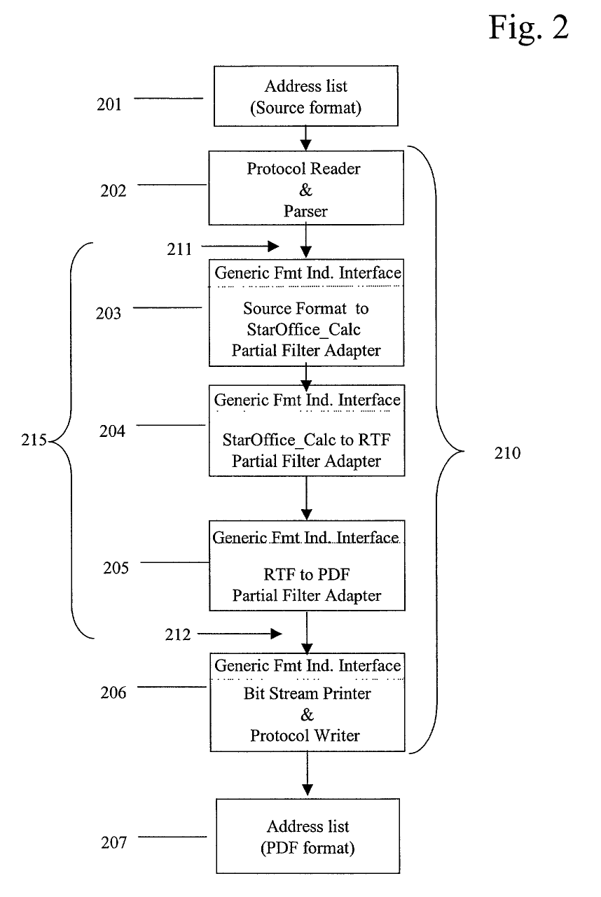

In response to the user request, in this embodiment, web server 111 sends a request that includes at least one MIME type supported by the browser on PC 102D and an address of the requested document to filter server 120. As explained more completely below, filter server 120 builds a filter 210 (FIG. 2) that can read the data from address list 201, dynamically convert the read data using a partial filter adapter chain 215 to the new format, and then write the converted data in the new format so that the data can be sent to the user.

More specifically, in response to the request from web server 111, filter server 120 via conversion service 125 causes a protocol reader 202(FIG. 2) to be instantiated and uses the protocol reader to access requested document 201 to determine the format of the requested data. With the source document data format and the target document data format, i.e., the MIME type received in the original user request, filter server 120 can build a filter 210 for converting the format of source document 201 to the format of the target document. In this example, address-list 201 was generated using a contact manager and so source document 201 has a format that, for purposes of illustration, is called the source format. A MIME type in the request, i.e., the target format, was Portable Document Format (PDF).

As explained more completely below, in one embodiment, filter server 120 accesses a filter registry 127 to generate a filter map of partial filter adapters that can be chained together to convert the format of address-list 201 to the PDF MIME type specified in the request. A filter map is an example of a rule set for constructing a chain of partial filter adapters that perform a desired data conversion.

In this example, the map of partial filter adapters includes three partial filter adapters 203 to 205. A first partial filter adapter 203 converts data in the source format to data in STAROFFICE Calc format. (STAROFFICE is a trademark of Sun Microsystems, Inc. of Palo Alto, Calif) A second partial filter adapter 204 converts data in STAROFFICE Calc format to data in the rich text format (RTF). A third partial filter adapter 205 converts data from the RTF format to the target PDF format.

Using the filter map, filter server 120 calls a service to instantiate each partial filter adapter in the map, e.g., instantiate each of partial filter adapters 203 to 205, using partial filter adapter library 126. Filter server 120 calls another service to chain the three partial filter adapters together using a chaining application programming interface of each partial filter adapter.

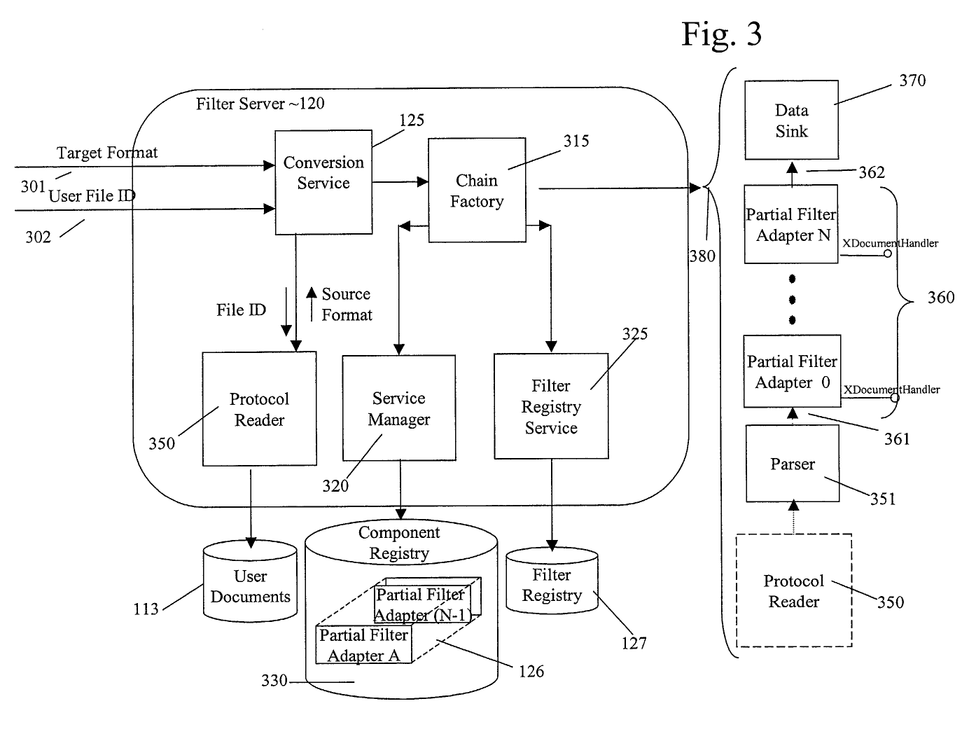

In this embodiment, filter server 120 via conversion service 125 constructs a data filter 210 (FIG. 3) by gluing a protocol read and parser unit 202 to an input end 211 of partial filter adapter chain 215 and a byte stream printer and protocol writer 206 to an output end 212 of chain 215 and thereby constructs filter 210. In more general, terms a data sink is glued to output end 212. The data sink converts the data presented via an event-based API to a byte stream that can be used by an application, or other process.

In the example of FIG. 2, after construction of filter 210, conversion service 125 uses filter 210 to process file 201. Specifically, source file 201, which was specified in the request from user device 102D, is read by a protocol reader, and if necessary, a parser parsers the input data read by the protocol reader to provide an event-based data stream to a source format to STAROFFICE Calc partial filter adapter 203. The output data from partial filter adapter 203 is provided via a generic format independent interface to a STAROFFICE Calc to RTF partial filter adapter 204. The output data from filter 204 is provided via the same generic format independent interface to RTF to PDF partial filter adapter 205.

The output data from partial filter adapter 205 is passed to byte stream printer and protocol writer 206. The byte stream printer converts the PDF data in the event-based API from partial filter adapter 205 to a byte stream and the protocol writer writes that byte stream to a memory either for storage or for transfer to user device 102D. In this example, filter 210 generates an address-list file 207 with a PDF format. File 207 is returned to web server 111, which in turn sends file 207 to user device 102D for display. Thus, the user is able to view the address-list without having access to the application that was used to generate the address-list.

One important aspect of this invention is that each partial filter adapter utilizes the same generic format independent interface to receive input data. Format independent here means that the interface is independent of the particular source and target formats as well as the underlying data formats associated with a particular partial filter adapter. This allows any one partial filter adapter to be connected to another partial filter adapter without concern for the particular underlying format of the data output by the first partial filter adapter. In one embodiment, as explained more completely below, the generic format independent interface is a Simple API for XML (SAX) interface, and the data format of the input data is XML. The underlying data format is defined by a Document Type Definition (DTD) identifier.

In one embodiment, filter 210 is used dynamically, which means that the complete data file is not stored in intermediate stages. Rather, the output from a first partial filter adapter is input to a second partial filter adapter before all the data has been processed by the first partial filter adapter.

As explained more completely below, in one embodiment, each partial filter adapter has two application programming interfaces. A first interface is the generic format independent interface event-based API that permits transfer of data from one partial filter adapter to another partial filter independent of the specific underlying format of the transferred data. A second interface is a chainable interface that allows chaining the partial filter adapters together. In another embodiment, the two interfaces are the same interface.

The combination of the two interfaces for each partial filter adapter permits dynamic building of a wide variety of filters. More importantly, data can be passed from one partial filter adapter to another partial filter adapter within a filter without waiting for one partial filter adapter to convert all the data from one format to another. This reduces the memory requirements for the data conversion.

The previous example assumed that the user requested data for display on user device 102D and that the user only wanted to view the requested data. However, alternatively, a user may be executing an application 112 or other service on server system 100, and the user directs application 112 to open a data file in a format different from the formats supported by application 112. In this case, the user wants to modify the data and then to store the modified data in its original format.

Upon application 112 determining that the requested data file has a format other than a format that can be processed by application 112, application 112 issues a request to filter server 120 that proceeds as described above. However, in this example, filter server 120 constructs a dynamic filter that is bi-directional, so that the original format of the requested data is changed to a new format using the filter in a first direction. The data in the new format is processed using application 112, and then the same dynamic filter is used in a second direction, opposite to the first direction, to store the processed data in the original format. Alternatively, two different filters could be used one for each direction. In some embodiments, the bi-directional data conversion may potentially lead to some information loss.

Hence, with filter server 120, a user can access data on Internet 106 and/or enterprise network 103 from almost any available device, e.g., any one of portable computer 102A, a mobile telephone 102B, a workstation 102C, a home personal computer (PC) 102D, a personal digital assistant 102E, or an Internet cafe machine 102F. No longer is a user limited to using a particular device with pre-installed software to access data with a particular format, or limited to using special devices, which support all capabilities needed to process the whole document.

As a further example, consider that a user taps an icon displayed on PDA 102E to generate a request for a sales report that is stored in a database in enterprise network 103. The request is sent over Internet 106 to server system 100 that, in turn, retrieves the sales report, dynamically builds a filter to convert the format of the sale report to another format that can be displayed on PDA 102E, and transmits the converted sales report to be displayed on PDA 102E. A similar transaction could be done using Internet cafe machine 102F, or perhaps mobile telephone 102D.

Plurality of devices 102A to 102F is illustrative only and is not intended to limit the invention to the particular devices illustrated. The devices could also include, for example, a POTS telephone, a pager, a set-top box connected to a television, a network appliance, or any other device that is connectable to a network and can issue a request for data, as described more completely below, and display the data received in response to the request.

In one embodiment, a request from a user device 102i, where user device 102i can be any one of the plurality of user devices 102A to 102F, specifies (i) a suitable address to the location where the content associated with the request is stored, for example, an address in the form of a uniform resource locator (URL), and (ii) information concerning either the types of data that can be processed and displayed by user device 102i, e.g., MIME types, or alternatively applications available on the device to process and display data. In another embodiment, the request includes the data to be converted in place of the storage location address.

Enterprise network 103 is illustrative only of one embodiment of a network. The particular type of network connecting a user device 102i to server system 100 is not essential, and may be the Internet or any other permanent or temporary network, for example a local area network.

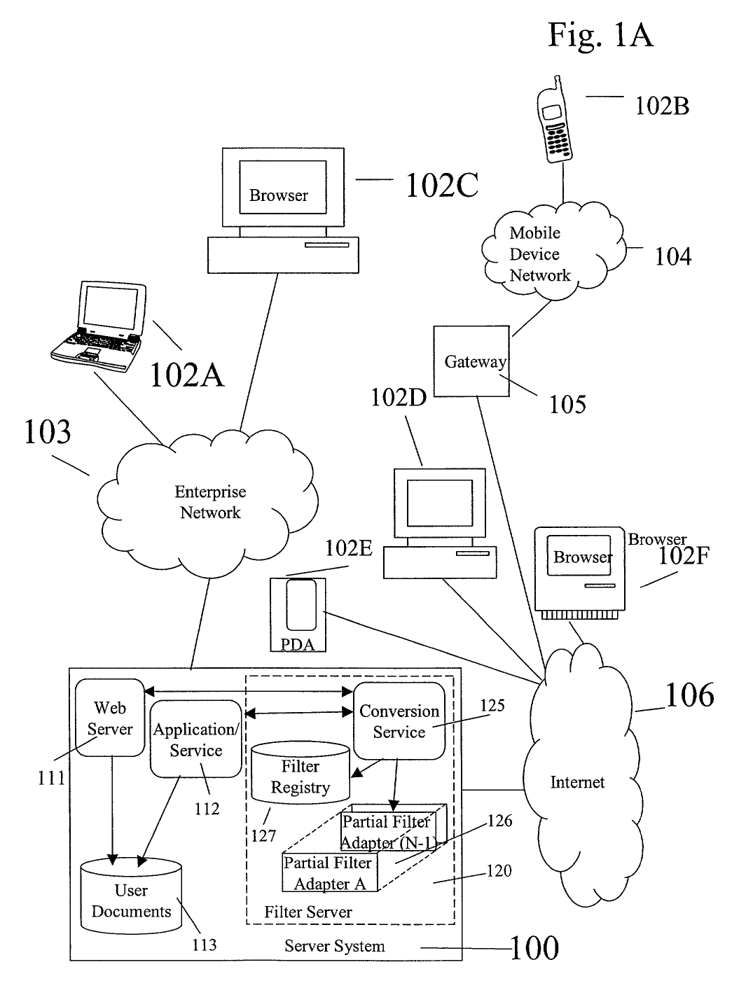

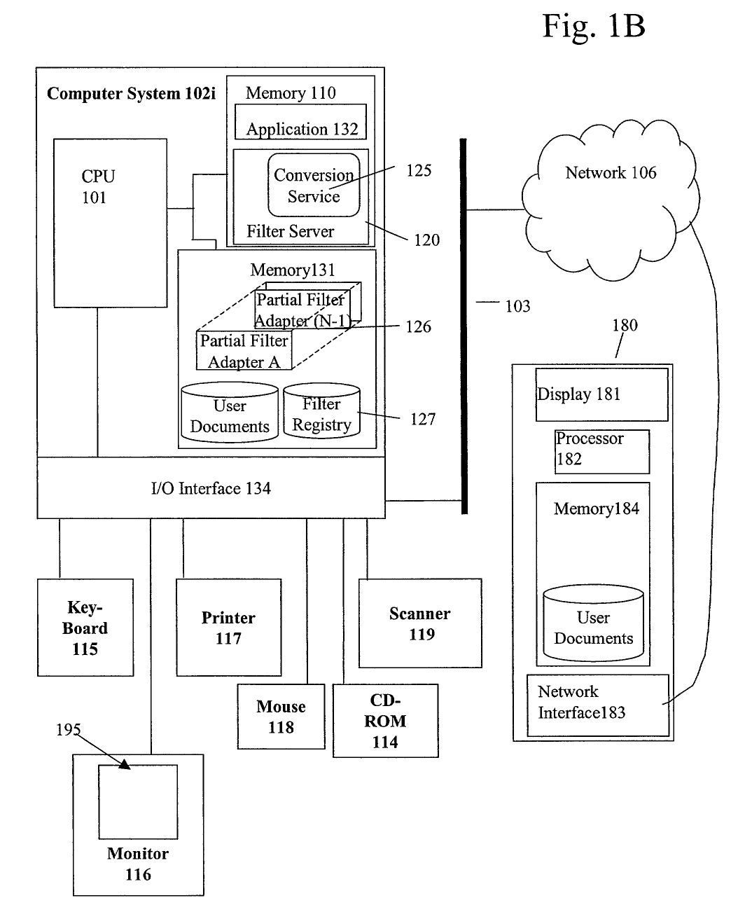

In the embodiment of FIG. 1A, filter server 120 was included in a server system 100. In the embodiment of FIG. 1B, filter server 120 is included on a user device 102i. In the embodiment of FIG. 1B, the memory of computer system 102i is divided into a volatile memory 110, like a working memory, and a non-volatile memory 131, like a hard disc. Filter server 120 is stored in memory 110, while partial filter adapter library 126 and filter registry 127 are stored in non-volatile memory 131. Of course, all or part of filter server 120 could also be stored in memory 131 and executed directly from memory 131, or alternatively, portions or modules of filter server 120, e.g., conversion service 125, could be loaded in memory 110 and executed as needed.

In this example, computer system 102i also includes keyboard 115, and monitor 116, that are connected to processor 101 via I/O interface 132. Computer system 100 also may have, for example, a printer 117, a mouse 118, a scanner 119 and CD-ROM 114 connected to I/O interface 134. Frequently, computer system 102i also is connected to a network 103 via I/O interface 134. Optionally, network 103 can be connected to, or part of a larger network 106, for example, the Internet or a wide area network.

If application 132 that is executing on processor 101 needs access to data that is in a format other than a format that can be opened by application 132, application 132 issues a request for the data to filter server 120 that proceeds as described above in this embodiment.

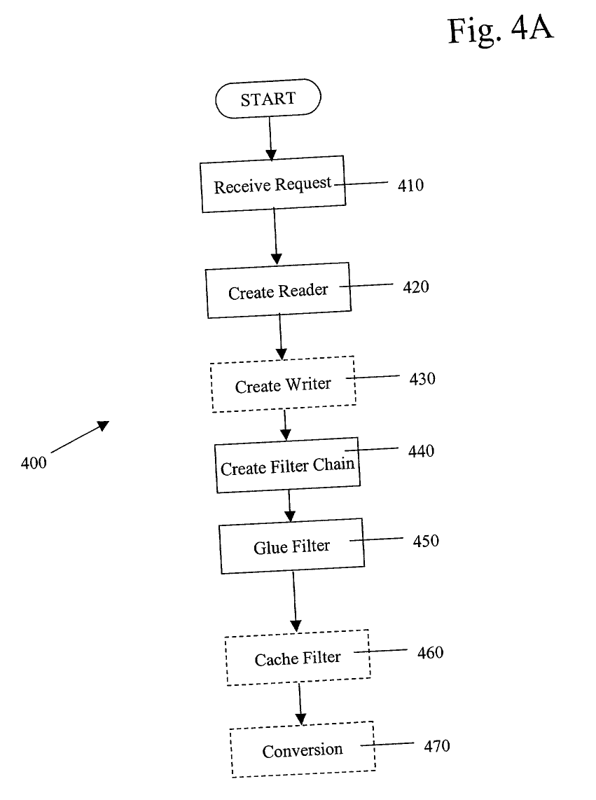

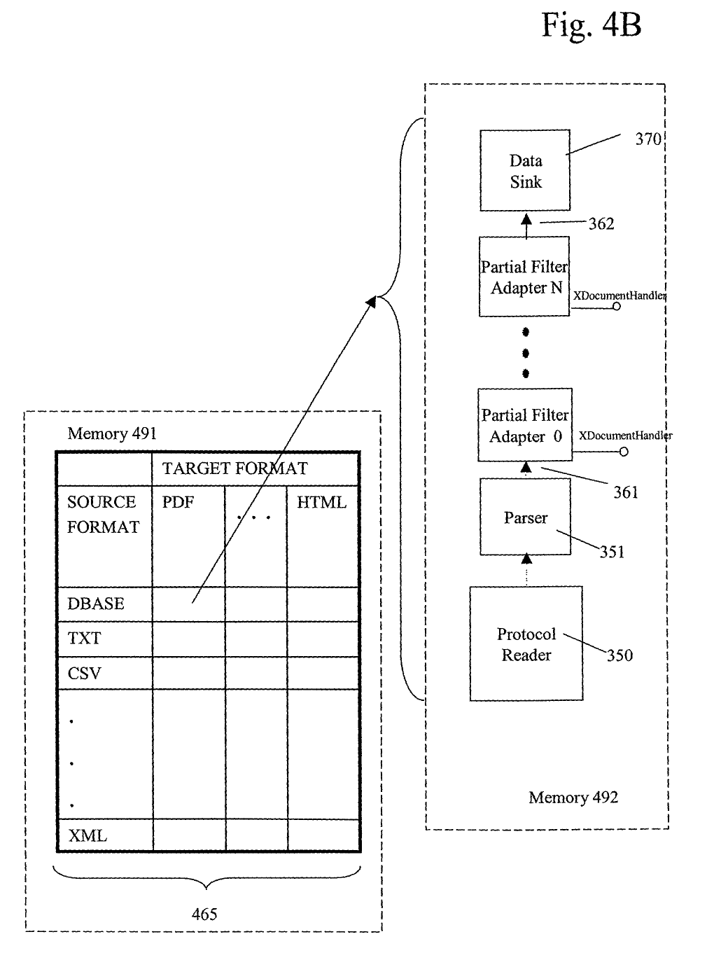

FIG. 3 is a block diagram of modules used in the process of building a chain 360 of partial filter adapters 0 to N by filter server 120. In this embodiment, in receive request operation 410 (FIG. 4A), conversion service 125 receives as a first input one or more data format types 301 that are specified, for example, by a character string identifier like a MIME type, or by a Document Type Definition (DTD) identifier from user device 102i, and in one embodiment from an importer for a target component of user device 102i. Herein, the importer and the target component may be one single component. The request from user device 102i and consequently the request to filter server 120 may include quality indicators (priority) for the input data format types 301. Conversion service 125 receives, as a second input 302, a source data identifier, which is illustrated in FIG. 3 as a user file ID. This can be a uniform resource locator, a document path, or in one embodiment, the document itself that is to be converted either as a data stream or in memory.

In the above examples, filter registry 127 was described as providing a filter map. However, this is illustrative only and is not intended to limit the invention to this particular embodiment. In general, a filter map is an example of a set of rules for constructing a filter that converts data from a first format to a second format, or constructing a filter that renders the same data in a different way. The set of rules could be defined, for example, using a XML decision tree or a computer programming language such as PROLOG.

Also, in one embodiment, library 126 includes general partial filter adapters. The function of a general partial filter adapter is controlled by a parameter or a set of parameters. One example of a general partial filter adapter is an extensible Style sheet Language Transformation (XSLT) processor. A XSLT script is used to define how this general partial filter adapter, i.e., the XSLT-processor, processes the data. Thus, by providing different scripts, the same general partial filter adapter can be used for different format conversions and/or filtering. In this case, the same general partial filter adapter is reused in building a filter, but the function of each general partial filter adapter in the filter is controlled by a different XSLT script. In this case, the XSLT script is the parameter for the partial filter adapter. In this example, the set of rules includes an identifier for the XSLT script that is to be used to construct a particular partial filter adapter.

In the embodiment of FIG. 3, conversion service 125 sets up a protocol reader 350 in create reader operation 420 to determine the source data format. Conversion service 125 passes the source data identifier, or at least a part of the source data identifier to protocol reader 350.

Protocol reader 350 retrieves the format of the source data. Some protocols like HTTP provide a MIME type directly and so protocol reader 350 simply retrieves the MIME type. For other protocols, format detection components, which read header information from the source data file itself, are needed in protocol reader 350. Protocol readers are known to those of skill in the art. In either case, conversion service 125 receives the format of the source data corresponding to the source data identifier from protocol reader 350. In another embodiment, the source data format is an input to conversion service 125.

Upon determining the source data format, in create reader operation 420, processing passes to an optional create writer operation 420, in one embodiment. At this point, conversion service 125 knows the target data format. As explained more completely below, conversion service 125 can transmit the converted data to an importer in a number of ways. The output data stream from the last partial filter adapter is presented via an event-based API. Typically, a byte stream printer is needed to convert the data presented via the event-based API to a byte stream that can be processed by other than an event-based API. Also, a protocol writer may be needed. Thus, create writer operation 403 creates a byte stream printer and/or protocol writer, if these components are needed to complete the filter for the data conversion. If neither of these components is needed, operation 420 transfers processing directly to operation 440 and otherwise operation 430 transfers processing directly to operation 440.

Conversion service 125 calls a chain factory 315 with at least the source data format and the target data format in create filter chain operation 440. Chain factory 315 calls filter registry service 325 and provides the source and target formats to service 325. Filter registry service 325 using filter registry 127 finds a chain of partial filter adapters, which is suitable for the conversion of data from the source data format to the target data format, e.g., from a first data format to a second data format. In another embodiment, service 325 finds a chain of filters to transcode the data, or alternatively to render the data in a different way.

In one embodiment of filter registry 127, each entry in registry 127 includes a identifier of the partial filter adapter, the source data format for that partial filter adapter, the target data format for that partial filter adapter, for example, by a MIME type or a DTD identifier, and an activation identifier. The entry also may contain quality indicators (priorities) as well as other attributes or options such as extract/strip/erase.

The particular chain chosen depends upon the information provided to filter registry service 325 and the information in filter registry 127. Note as indicated above, if filter registry service 325 receives more than one target data format, service 325 uses a selection scheme to select the target data format.

The selection scheme uses, as an example, one or more of the following criterion: storage space required by the data in each of the data formats supported by the software program on user device 102i used to process the data; and conversion time from the first data format into each of the data formats supported by the software program or programs on user device 102i. There may be other criteria furthering the aim of providing quick and easy access with a good quality to data stored in a computer system. If there are no other constraints, a chain with the least number of partial filter adapters is selected. In all cases, a descriptive representation of the partial filter adapter chain is returned to chain factory 315 by filter registry service 325 in create filter chain operation 440.

Next in create filter chain operation 440, chain factory 315 passes the descriptive representation of each partial filter adapter in the chain to service manager 320 in a request to activate each partial filter adapter. Service manager 320 accesses each partial filter adapter in library 126 within component registry 330 and instantiates the partial filter adapter, and returns a pointer to the partial filter adapter to chain factory 315.

After service manager 320 instantiates each partial filter adapter, chain factory 315 creates a partial filter adapter chain 360 by connecting the newly created partial filter adapters together. The chain connections are built by using an interface of each partial filter adapter. As explained above, in one embodiment, each partial filter adapter includes a chainable API and this API is used to connect each partial filter adapter to the next partial filter adapter in the chain.

In one embodiment, the chaining is done by setting a Simple API for XML (SAX) interface XDocumentHandler (See Table 8) of each successor partial filter adapter to the predecessor's partial filter adapter. One embodiment of the methods in the SAX interface XDocumentHandler is described more completely below. Upon completion of chain 360, create filter chain operation 440 returns chain 360 to conversion service 125 and processing transfers from operation 440 to glue filter operation 450.

In glue filter operation 450, conversion service 125 connects protocol reader 350 and parser 351 to input end 361 of chain 360. Conversion service 125 also connects a data sink 370, e.g., a byte stream printer and protocol writer generated in create writer operation 430 to output end 362 of chain 360 to complete generation of filter 380.

In one embodiment, conversion service 125 caches a pointer to completed filter 380 so that any subsequent calls that require the data conversion performed by filter 380 can be completed without building another filter. An example of such a cache for filter 380 is presented in FIG. 4B. For this example, it is assumed that filter 380 performs the dBase to PDF conversion described above. In this embodiment, cache 465 in memory 491 is a two-input look-up table. Use of a lookup table is illustrative only and is not intended to limit the invention to this particular embodiment.

For two-input lookup table 465, a first input, the source format, provides an index that is used to address a row of lookup table 465. A second input, the target format, is another index that is used to address a column of lookup table 465. Here, the source format is the format in which the requested data is stored, and the target format is the format of the data that can be processed by the computer system receiving the data.

The cell of lookup table 465 at the intersection of the addressed row and column contains the pointer to the filter the source and target formats. In this example, the pointer to filter 380 is at the intersection of the row for a source dBase format and the column for a target PDF format. If the filter generated by filter server 120 is not cached, cache filter operation 460 is not included in the process, and processing transfers from glue filter operation directly to conversion operation 470.

Conversion operation 470 may be performed by conversion service 125. In this case, conversion service 125 uses filter 380 to convert the specified file from the source format to the target format. Alternatively, conversion service 125 can return either filter 380 or a pointer to filter 380 to another process or application, and that process or application user filter 380 to perform conversion operation 470.

In conversion operation 470, filter 380 converts data from the first data format to the second data format. According to one embodiment of this invention, complete filter 380 is not stored in it entirety all at one time in dynamic memory of the computer system carrying out the conversion of data. Instead, each partial filter adapter, in turn, cooperates with the next partial filter adapter by exchanging directly information in an intermediate data format. Therefore, as the data is converted from the first data format into the second data format, a complete stream or file of data in the intermediate data format, or intermediate data formats, need not exist at any time in a memory of the computer system carrying out the conversion. However, pieces of the stream of file of data in the intermediate data format, of course, may exist at any given point in time.

In the previous description, each partial filter adapter was described as converting input data in one format to input data in another format. However, partial filter adapters are not limited solely to format conversion. Alternatively, a partial filter adapter can strip information contained in the data, which is not relevant for the representation of the data in the output data format. For example, if the computer software program supporting the second data format and running on the second computer system is programmed to exclusively present an outline of the original source data, a partial filter adapter is used strip all detailed information from the data, e.g., all but the outline is stripped so that only the outline is subsequently processed in the filter of this invention.

Another example is to remove all layout and formatting information from the data via a partial filter adapter. This means that only the filter subsequently processes the content itself. This may be useful, if the computer program that requested the data has no capability to use the layout and formatting information.

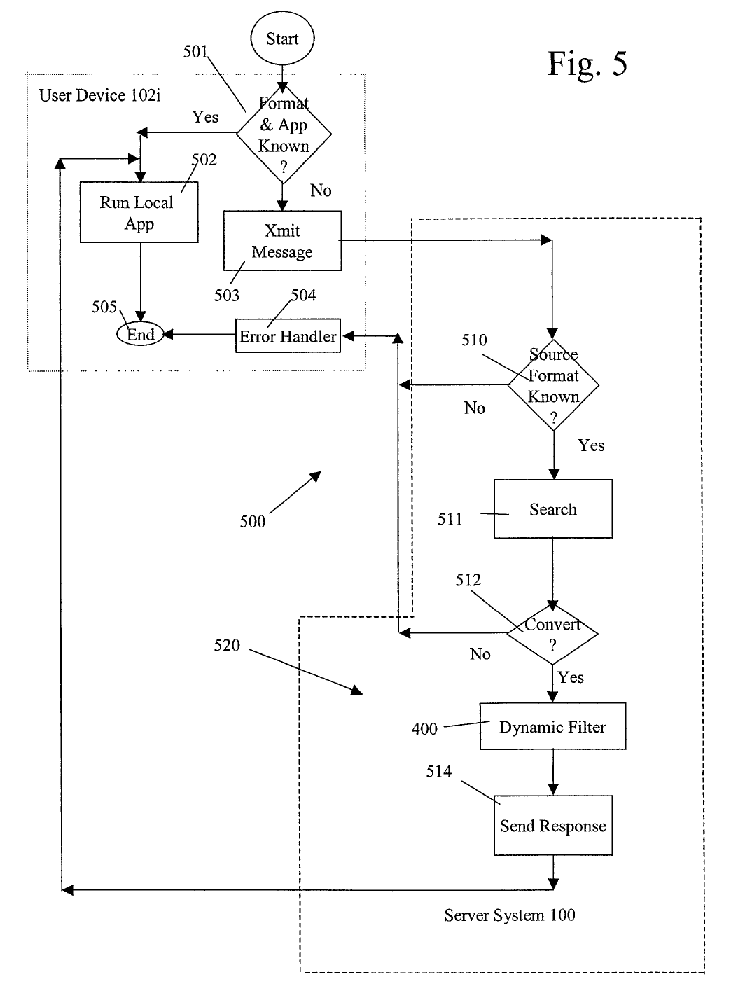

Process 500 (FIG. 5) is one embodiment of a use of method 400. Typically, in source format known check operation 501, a user application or a browser, executing on a user device 102i, where user device 102i can be any one device in the plurality of user devices 102A to 102F, determines whether the format for the user requested data (the source format) is known and whether a local application is available, which can read data with the source format. This can be done by searching a registration database, or simply by trying all available applications. If the source format is known and a local application is available, which can read data with the source format, processing transfers to run local application operation 502 on user device 102i, and otherwise to transfer message operation 503.

In run local application operation 502, the local application reads the data in the source format and displays the data on user device 102i. Upon displaying the data, method 500 is complete and so processing transfers to end 505. When it is said that a user device, or in fact any computer system, knows something or takes some action, those of skill in the art will understand that this means that an instruction or instructions are executed on the device to determine what is known or to cause the stated actions to be performed.

In transmit message operation 503, user device 102i sends the request for the data to server system 100. The information included in the request depends on the results of check operation 501. The request includes an identifier of the requested data, a source format field and a target format field. If the source format is completely unknown, the source format field is set to an illegal value, and a list of identifiers of data formats supported by user device 102i is placed in the target format field. Alternatively, an identifier for user device 102i could be provided. If the source format is known, but no appropriate application was found on device 102i, a source format identifier is written in the source format field. The target format field is completed as just described. The message is transmitted to server system 100.

In this example, it was assumed that the user only wanted to view the data and so user device 102i only needed capability for opening the requested document. If for example, the user was requesting the data with one application, e.g., a browser or viewer, but wanted to edit the document using another application after the document was received, the above decision process would be more complex. The application would require logic to make the necessary determinations. For example, the decision could be made to use a remote application to process the data after the data format conversion, and so a lightweight component would need to be downloaded and the desired format would depend on the capabilities of the remote application. See for example, U.S. patent application Ser. No. ______, entitled “METHOD AND SYSTEM FOR REMOTE CONTROL AND INTERACTION WITH A RUN TIME ENVIRONMENT COMPONENT,” of Ralf Hofmann and Torsten Schulz (Attorney Docket No. P-4596), which is incorporated herein by reference in its entirety. Independent of the decision process used on the client side to determine the target format, the message sent by client device 102i specifies at least an identifier of the requested data, and an indication of a target format.

Upon receipt of the message from client device 102i, source format known check operation 510 determines either whether the source format field in the message includes a legal value or whether the format of the source file can be detected. If either the source format field includes a legal value or the format of the source file can be detected, the source format is known and so processing transfers to convert check operation 512. Alternatively, the source format is unknown, and check operation 510 transfers to error handler operation 504 that terminates method 500.

In process 500, the operations performed on server system 100 could be performed by different modules executing on server system 100 in a first embodiment, and by a single module in a second embodiment. The particular module or modules that perform the operations of process 500 on server system 100 is not essential to this invention.

In search operation 511, if a user device identifier was provided, operation 511 first obtains information about user device 102i and available software on user device 102i. For example, operation 511 retrieves information about supported data formats from a database, or from other stored information about the type or nature of the software program and user device 102i. For example, if it is known that a text processing software program supports a certain data format, it may be sufficient to obtain the name of the text processing software program from user device 102i to obtain indirectly the required information about the certain data format supported by the text processing software program from a data source accessible to search operation 511 that is executing on server system 100.

When search operation 511 has a set of possible target formats, operation 511 finds a best combination of partial filter adapters to convert the data in the source format into data in the target format. If no conversion is possible, the set of partial filter adapters found is an empty set.

Thus, on entry to convert check operation 512, the data format of the requested data is known; the data format processing capabilities of user device 102i are known; and a set of partial filter adapters for converting the data is known. If convert check operation 512 determines that the set of partial filter adapters is not empty, check operation 512 transfers processing to dynamic filter method 400 and otherwise to error handler operation 504. Error handler operation 504 terminates processing because a set of partial filter adapters for use in transforming the source data to one of the target format supported by user device 102i was not found.

In dynamic filter method 400, a filter is constructed using the set of partial filter adapters, as described above. The filter is used to transform the data from the source format to the target format. Send operation 514 forwards the requested and transformed data, in this embodiment, to run local application operation 502 that performs as described above.

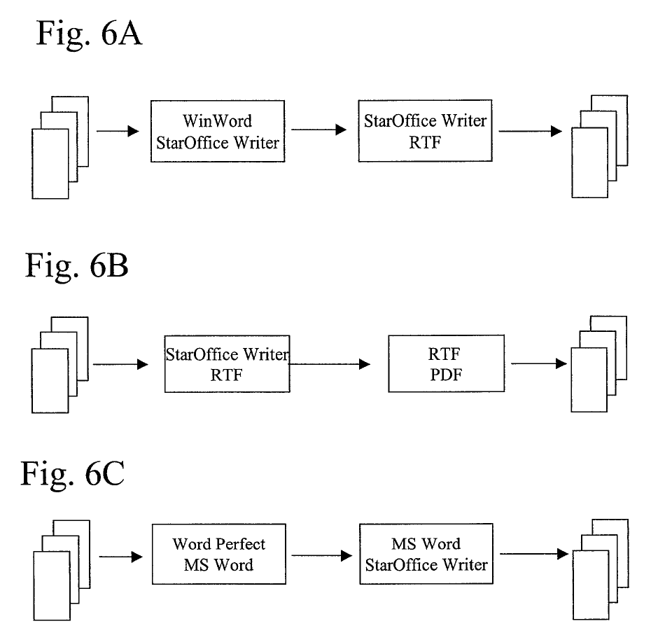

In FIGS. 6A to 6C, examples for converting documents from one source data format into another target data format are shown. In FIG. 6A, method 400 starts with a document in the Microsoft WinWord format (the WinWord format) that was requested for use in an application that uses the RTF format. In this example, method 400 generates a filter employing one partial filter adapter for converting the document in the WinWord format into data having the STAROFFICE-Writer format and another partial filter adapter for converting the data in the STAROFFICE-Writer format into a document having the RTF format.

In the example in FIG. 6B, a source document in the STAROFFICE-Writer format is converted into a PDF (Portable Document Format) document. Hence, filter method 400 starts with a document in the StarOffice-Writer format that was requested for use in an application that uses the PDF format, e.g., the user only wants to view the document. A first partial filter adapter converts the STAROFFICE-Writer format into a RTF format. A second partial filter adapter converts the RTF format into the PDF format.

In FIG. 6C, the first data format is WordPerfect 2001 and the second data format is STAROFFICE Writer. The first partial filter adapter converts the data from WordPerfect 2001 format to MS Word 2000 format, while the second partial filter adapter converts the MS Word 2000 format to STAROFFICE Writer format.

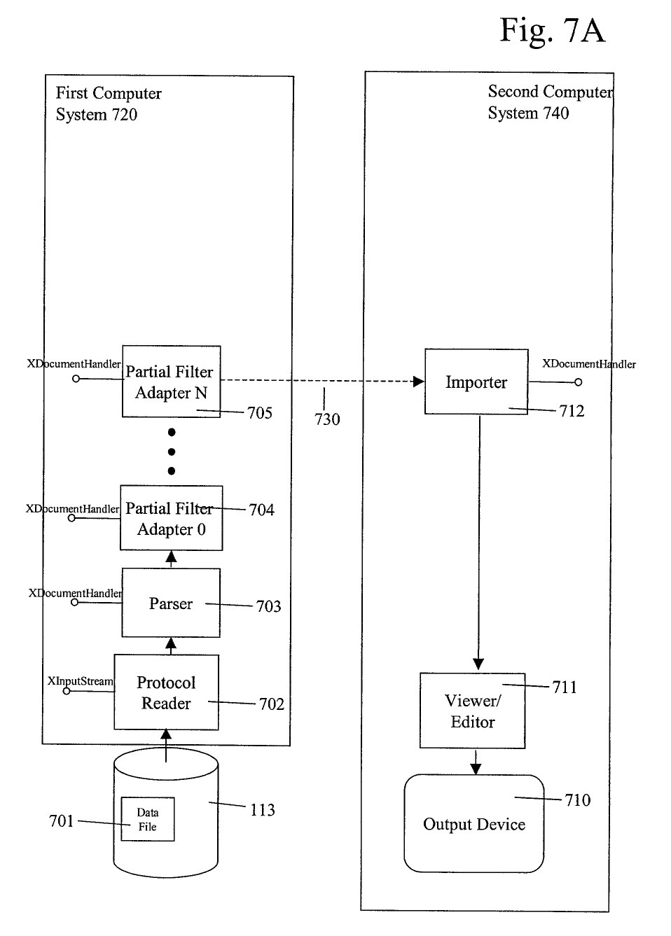

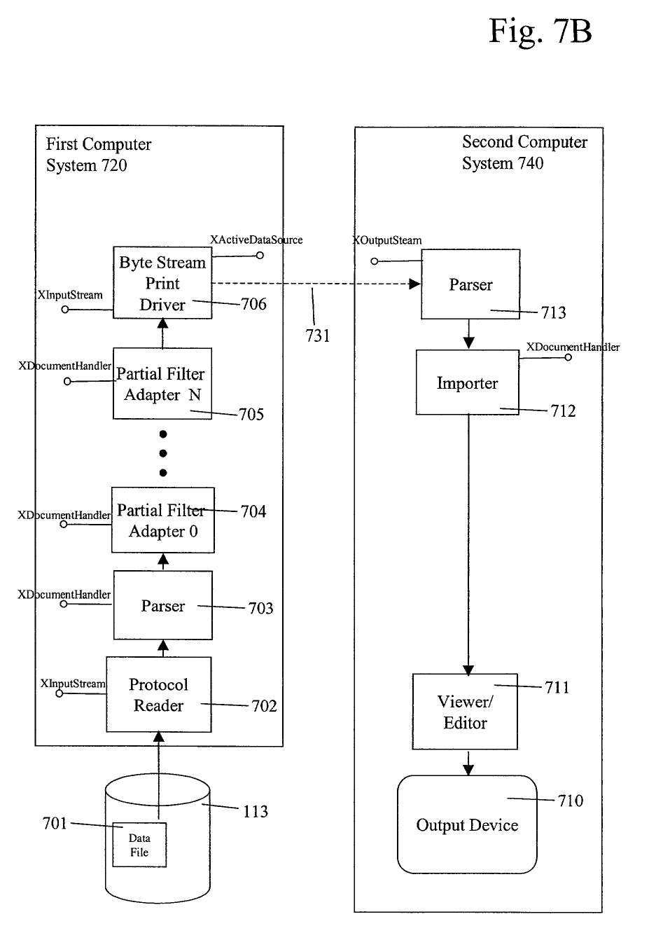

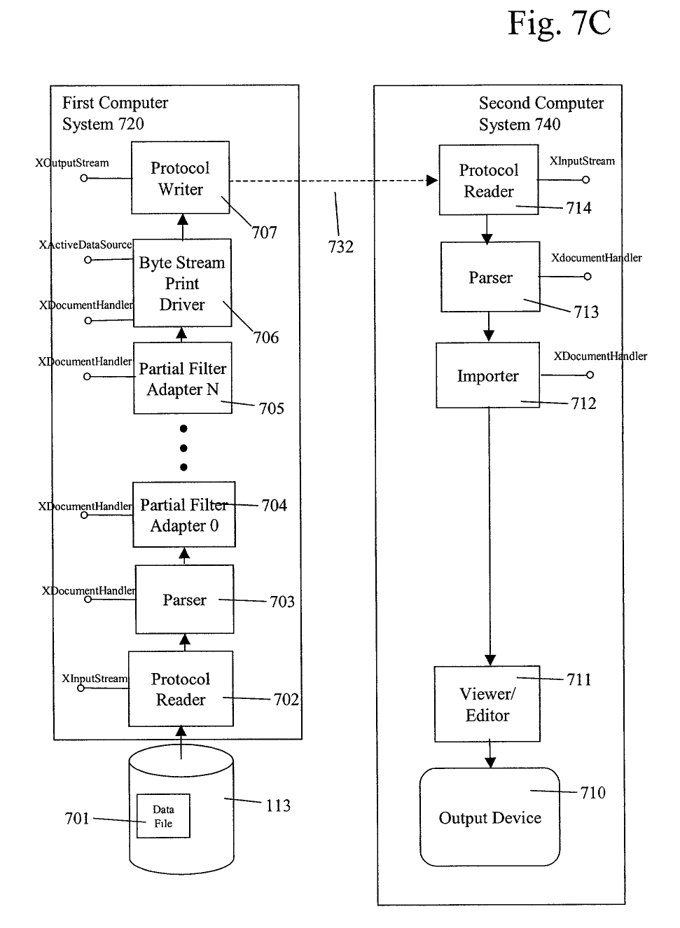

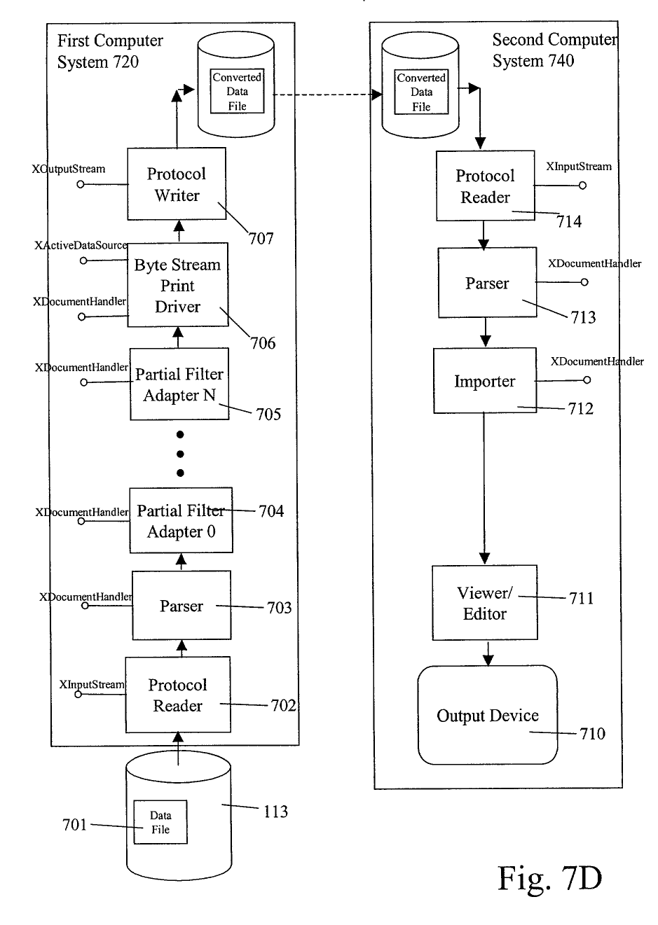

FIGS. 7A to 7D are examples of the use of different filters that can be built using filter server 120 of this invention. In FIG. 7A, the structure of a data file 701 on a storage medium 113 accessible by a first computer system 720 is modified and provided to an output device 710, e.g., a speaker, a display, or a printer on a second computer system 740.

If storage medium 113 is not included within first computer system 720, data file 701 is accessible on demand via a network connection, for example, using special protocols like HTTP or FTP. Note that the request for data file 701 could have originated on computer system 720, computer system 740, or another computer system that is not shown. If the request originated from a computer system other than the computer system that ultimately processes the target data, e.g., system 740, the request included routing information so that data can be routed to the appropriate location.

To access data file 701 for further handling and processing, data file 701 is transferred from storage medium 113 to first computer system 720. In this embodiment, protocol reader 702 reads source data from an external representation of the data, here data file 701 on storage medium 113, into first computer system 720. Specialized protocol readers for different protocols exist, for example, protocol readers for protocols FILE, HTTP and FTP, respectively.

Protocol reader 702 has an interface, which allows reading the original source data. This interface provides access to the requested data file that means to the original source data. An example of this interface is interface XInputstream (See Table 1). Interface XInputStream is an interface for sequentially reading data from a data source. Such an interface has at least a method to read data, for example, method readBytes in interface XInputStream (See Table 1.).

Parser 703 parses the original source data stream of original data file 701 via the interface provided by protocol reader 702. For example, in one embodiment, parser 703 is an XML parser, which disassembles the original source data stream into XML tokens and contents.

Parser 703 uses a data sink interface, here for example SAX interface XDocumentHandler (Table 8), to forward the parsed data to a first partial filter adapter component 704. This data sink interface is generic and does not depend on the concrete document type of the original source data. In this embodiment, each partial filter adapter, in turn, uses the same generic interface XDocumentHandler to pass the data stream to the next partial filter adapter. In this embodiment, XML data is used to implement the generic format independent interface between the partial filter adapters. Specifically, each partial filter adapter component forwards the (partially) converted data to the next partial filter adapter component in the chain by using interface XDocumentHandler. The interfaces between the partial filter adapter components in this chain are the same and independent from the concrete document type.

The use of interface XDocumentHandler in the partial filter adapters is illustrative only and is not intended to limit the invention to this specific interface. Other similar interfaces may be used. Each partial filter adapter can be, for example, hard coded, or can be implemented by XSLT transformations, using an XSL processor and XSL transformation descriptions.

Each of these partial filter adapter components can either convert one format to another format without changing the information itself, or can add or reduce the information contained in the data, for example, by using third data sources like databases or reduction rules.

In the embodiment of FIG. 7A, the last partial filter adapter 705 is adapted to issue a remote call over a network connection 730 to interface XDocumentHandler of an importer 712 for a target component 711. This effectively forwards the converted data directly to output device 710.

Importer 712 of target component 711 receives the target data by interface XDocumentHandler and builds an internal representation of the target data, for example a target document. Importer 712 may be part of target component 711. In the present examples, importer 712 is separated to give a clearer picture of the process.

Importer 712 calls native functions of target component 711 to build the internal presentation of the target data within target component 711. Interfaces belonging to target component 711 are used in building the internal presentation. Each target component 711 has interfaces that are known to those of skill in the art, and so are not considered further herein.

Target component 711, which is used to process the target data, can be, for example, a viewer, an editor or any other component, which processes data. Target component 711 has its own set of interfaces or other methods of receiving the target data.

Optionally, target component 711 may use a display component to present the document in a rendered (or any other) form to the user of second computer system 740. However, output device 710 can be any output device of second computer system 740 including, for example, the display or the loudspeaker of a computer or mobile phone.

Elements 702 to 704 in FIG. 7B are identical to those described above for FIG. 7A and so that description is incorporated herein by reference. However, in the embodiment of FIG. 7B, partial filter adapter 705 is not configured to communicate via a connection to computer system 740. Partial filter adapter 705 provides the converted data to a byte stream printer 706 via interface XInputStream in this example.

At this point, the original source data from data file 701 has been converted from the first data format, i.e., the original source data format, into an event-based target data format. From this event-based target data format, byte stream printer 706 converts the internal representation of the converted data into a representation in the second data format, which can be transferred to second computer system 740 as a binary stream. Byte stream printer 706 has a document type independent output interface, which in this embodiment is interface XActiveDataSource.

Byte stream printer 706 issues a remote call over a network connection 731 to interface XOutputStream of a parser 713 in second computer system 740. This is yet another example for the transfer of the converted data to the target system. In this case, simple data blocks can be transmitted over network connection 731. However, direct (unbuffered) polling data from remote computer systems may not be extremely efficient.

Parser 713 reads the data of the target file from byte stream printer 706 using interface XOutputStream. Parser 713 parses the target data stream of the target file from printer driver 706 and provides data to interface XDocumentHandler of importer 712. Elements 712 to 710 in FIG. 7B are identical to those described above for FIG. 7A and so that description is incorporated herein by reference.

Elements 702 to 705 in FIG. 7C are similar to those described above for FIG. 7B and so that description is incorporated herein by reference. However, in the embodiment of FIG. 7C, byte stream print 706 receives converted data from the prior partial filter adapter by the same document type independent interface, that means interface XDocumentHandler or a similar interface.

Byte stream printer 706 uses, for example, interface XActiveDataSource to write the data in the target data format to protocol writer 707. Interface XActiveDataSource is an interface for sequentially writing data to a target component by registering an interface XOutputStream to receive the data.

Protocol writer 707 creates a data file from the target data obtained from bit steam printer 706. Depending on the protocol used to create the target data file, a different protocol writer component is used. In this embodiment, a specialized protocol writer 707 is used on first computer system 720. Protocol writer 707 directly communicates using any network protocol with a specialized protocol reader 714 on second computer system 740 via network connection 732.

Protocol reader 714 on second computer system 740 reads the target data file into the software system. Specialized readers for different protocols may exist, i.e. for FILE, HTTP or FTP. Protocol reader 714 uses interface XInputStream to provide the target data to parser 713. Elements 713 to 710 function as described above, and that description is incorporated herein by reference.

FIG. 7D illustrates an embodiment of the invention that is similar to the embodiment of FIG. 7C. The difference is that in the embodiment of FIG. 7D, protocol writer 707 and protocol reader 714 do not communicate directly. In this example, a file system writer is created which in turn creates the target file with the target data in the file system of first computer system 720.

The target data file, which is locally stored in first computer system 720, is transferred (copied) to the file system on second computer system 740. Parser 713 reads the data of the target file from the protocol reader 714 using the interface XInputStream. Preexistent software can be used on second computer system 740, if target element 711 actually contains all of elements 712 to 714. Alternatively, to the depicted usage in two computer systems 720 and 740, this invention can be used on a single computer system too, as shown in FIG. 4.

Table 1 is one embodiment of interface XInputStream that was used in the protocol readers described above. Interface XInputStream is a basic interface to read data from a stream. Interface XInputStream inherits from interface XInterface that is presented in Table 2. In this embodiment, interface XInputStream includes methods readBytes, readSomeBytes, skipBytes, available, and closeinput. As shown in Table 1, each method can raise one of a plurality of exceptions including NotConnectedException (Table 6), BufferSizeExceededException (Table 7), and IOException (Table 4).

Method readBytes reads the specified number of bytes in the given sequence. The return value specifies the number of bytes, which have been put into the sequence. A difference between input parameter nBytesToRead and the return value indicates that an EOF has been reached. This method blocks the thread until the specified number of bytes are available or the EOF is reached. Some implementations must buffer their data to fulfill their specification, and if so exception BufferSizeExceededException may be thrown. When the object is not connected to another interface XInputStream (the need for a connection must be specified by the service specification) exception NotConnectedException is thrown. Exception IOException is thrown when a general IO error occurs.

Method readSomeBytes reads the available number of bytes and at maximum the number of bytes specified by input parameter nMaxBytesToRead. This method blocks the thread until at least one byte is available. This method returns the number of bytes actually read. If zero is returned, EOF has been reached. The exceptions thrown by this method were described above.

Method skipBytes skips the next nBytesToSkip bytes (must be positive). It is up to the implementation whether this method is blocking the thread or not.

Method available states how many bytes can be read or skipped without blocking. This method offers no information on whether the EOF has been reached.

Method closeInput closes the stream. Users must close the stream explicitly when no further reading should be done. (There may exist ring references to chained objects that can only be released during this call. Thus, not calling this method would result in leak of memory or external resources.

TABLE 1
INTERFACE XInputStream

interface XInputStream: com: :sun: :star: :uno: :XInterface
{
long readBytes( [out] sequence<byte> aData,

[in] long nBytesToRead )

raises ( com: :sun: :star: :io: :NotConnectedException,
com: :sun: :star: :io: :BufferSizeExceededException,
com: :sun: :star: :io: :IOException) ;

long readSomeBytes( [out] sequence<byte> aData,

[in] long nMaxBytesToRead )

raises ( com: :sun: :star: :io: :NotConnectedException,
com: :sun: :star: :io: :BufferSizeExceededException,

com: :sun: :star: :io: :IOException );

void skipBytes( [in] long nBytesToSkip )

raises ( com: :sun: :star: :io: :NotConnectedException,
com: :sun: :star: :io: :BufferSizeExceededException,

com: :sun: :star: :io: :IOException );

long available ()

raises (
com: :sun: :star: :io: :NotConnectedException,

com: :sun: :star: :io: :IOException );

void closeInput ()

raises ( com: :sun: :star: :io: :NotConnectedException,

com: :sun: :star: :io: :IOException) ;

} ;

Interface XInterface (Table 2) is the base interface for other interfaces and provides lifetime control by reference counting. Interface XInterface also provides the possibility of querying for other interfaces of the same logical object. Logical object in this case means that the interfaces actually can be supported by internal, i.e., aggregated, physical objects. Method querylnterface in interface XInterface queries for a new interface to an existing object. Method acquire increases a reference counter by one, while method release decreases the reference counter by one. When the reference counter reaches a value of zero, the object is deleted.

TABLE 2
INTERFACE XInterface

//===================================================
interface XInterface
{
//---------------------------------------------------
any queryInterface ( [in] type aType ) ;
[oneway] void acquire ();
[oneway] void release ();
};

One embodiment of structure Uik is presented in Table 3.

TABLE 3
Structure Uik

//===================================================
/** specifies a universal interface key.
An UIK is an unambiguous 16-byte value for every
interface.
*/
struct Uik
{
//---------------------------------------------------
// specifies a 4 byte data block.
unsigned long m_Data1;
//---------------------------------------------------
/// specifies a 2 byte data block.
unsigned short m_Data2;
//---------------------------------------------------
/// specifies a 2 byte data block.
unsigned short m_Data3;
//---------------------------------------------------
/// specifies a 4 byte data block.
unsigned long m_Data4;
//---------------------------------------------------
/// specifies a 4 byte data block.
unsigned long m_Data5;
} ;
//===================================================

Exception IOException (Table 4) in interfaces XInputStream (Table 1), and XOutputStream (Table 12) inherits from exception Exception (Table 5). Exception IOException is thrown when an input or output error has occurred.

TABLE 4
EXCEPTION IOException

exception IOException: com: :sun: :star: :uno: :Exception
{
} ;

Exception Exception is the basic exception. All exceptions are derived from this exception. Message specifies a detailed message of the exception or an empty string if the callee does not describe the exception. Context is an object that describes the reason for the exception. Context may be NULL if the callee does not describe the exception.

TABLE 5
EXCEPTION Exception

exception Exception
{
string Message;
com: :sun: :star: :uno: :XInterface Context;
} ;

Exception NotConnectedException (Table 6) in interfaces XInputStream (Table 1), and XOutputStream (Table 12) inherits from exception IOException (Table 4). Exception NotConnectedException is thrown when a read/write operation is tried on an instance that has not been chained properly.

TABLE 6
EXCEPTION NotConnectedException

exception NotConnectedException:

com: :sun: :star: :io: :IOException

{
} ;

Exception BufferSizeExceededException (Table 7) in interfaces XInputStreamn (Table 1), and XoutputStream (Table 12) inherits from exception IOException (Table 4). Exception BufferSizeExceededException is thrown by instances, which need to buffer data. This exception indicates that not enough system resources are available for extending the buffer. This exception May also indicate that the internal buffer has grown to a larger size than 2 GBytes. Some current implementations do not support larger buffers.

TABLE 7
EXCEPTION BufferSizeExceededException

exception BufferSizeExceededException:
com: :sun: :star: :io: :IOException
{
} ;

Interface XDocumentHandler (Table 8) also inherits from interface XInterface (Table 2). Interface XDocumentHandler receives notification of general document events. In this embodiment, interface XDocumentHandler includes methods startDocument, endDocument, startElement, endElement, characters, ignorableWhitespace, processingInstruction, and setDocumentLocator. Each of these methods can raise an exception SAXException. One embodiment of exception SAXException is presented in Table 9.

Method startdocument receives notification of the beginning of a document. Method endDocument receives notification of the end of a document.

Method startElement receives notification of the beginning of an element. Input parameter aName contains the name of the tag. Input parameter xAttribs contains an interface to the list of attributes given in the tag. Note that for every call of the method, the same instance may be passed. So one must make copy of the instance to store the information.

Method endElement receives notification of the end of an element. Method characters receives notification of character data. Method ignorableWhitespace receives notification of white space that can be ignored. Method processingInstruction receives notification of a processing instruction. Method setDocumentLocator receives an object for locating the origin of SAX document events.

TABLE 8
Interface XDocumentHandler:

interface XDocumentHandler:

com: :sun: :star: :uno: :XInterface

{
void startDocument ()

raises ( com: :sun: :star: :xml: :sax: :SAXException ) ;

void endDocument ()

raises( com: :sun: :star: :xml: :sax: :SAXException ) ;

void startElement ( [in] string aName,

[in] com: :sun: :star: :xml: :sax: :XAttributeList
xAttribs )

raises (
com: :sun: :star: :xml: :sax: :SAXException );

void endElement ( [in] string aName )

raises ( com: :sun: :star: :xml: :sax: :SAXException ) ;

void characters ( [in] string aChars )

raises( com: :sun: :star: :xml: :sax: :SAXException ) ;

void ignorableWhitespace ( [in] string aWhitespaces ) ;

raises( com: :sun: :star: :xml: :sax: :SAXException );

void processingInstruction ( [in] string aTarget,

[in] string aData )

raises (
com: :sun: :star: :xml: :sax: :SAXException ) ;

void setDocumentLocator (

[in] com: :sun: :star: :xml: :sax: :XLocator xLocator )
raises( com: :sun: :star: :xml: :sax: :SAXException ) ;

} ;

Exception SAXException also inherits from exception Exception (Table 5). Exception SAXException encapsulates the details of an XML parse error or warning.

TABLE 9
EXCEPTION SAXException

exception SAXException: com: :sun: :star: :uno: :Exception
{
/** This field may contain a wrapped exception
*/
any WrappedException;
} ;

Interface XAttributeList is used in method startElement of interface XDocumentHandler (Table 8). Interface XAttributeList inherits from interface XInterface (Table 2). Interface XAttributeList specifies an element's attributes. This interface describes a name-type-value triple, which describe a single attribute of a tag.

Method getLength returns the number of attributes in this list. Method getNameByIndex returns the name of an attribute in this list by position. Method getTypeByIndex returns the type of an attribute in the list by position. Non-validating parsers may return CDATA only. Method getTypeByName returns the type of an attribute in the list by name. Non-validating parsers may return CDATA only. Method getValueByIndex returns the value of an attribute in the list by position. Method getValueByName returns the value of an attribute in the list by name.

TABLE 10
INTERFACE XAttributeList

interface XAttributeList:

com: :sun: :star: :uno: :XInterface

{
short getLength () ;
string getNameByIndex ( [in] short i ) ;
string getTypeByIndex ( [in] short i ) ;
string getTypeByName ( [in] string aName ) ;
string getValueByIndex ( [in] short i ) ;
string getValueByName ( [in] string aName ) ;
} ;

Interface XLocator is used in method setDocumentLocator of interface XDocumentHandler (Table 8). Interface XLocator inherits from interface XInterface (Table 2). Interface XLocator makes it possible to associate a SAX event with a document location.

Method getColumnNumber returns the column number where the current document event ends. Method getLineNumber returns the line number where the current document event ends. Method getPublicId returns the public identifier for the current document event. Method getSystem ID returns the system identifier for the current document event.

TABLE 11
INTERFACE XLocator

interface XLocator: com::sun::star::uno::XInterface
{
long getColumnNumber();
long getLineNumber();
string getPublicId();
string getSystemId();
};

Interface XOutputStream inherits from interface XInterface that is presented in Table 2. Interface XOutputStream is the basic interface to write data to a stream. In this embodiment, interface XOutputStream includes methods writeBytes, flush, and closeOutput that are each briefly described within Table 12. As shown in Table 12, each method can raise one of a plurality of exceptions including NotConnectedException (Table 6), BufferSizeExceededException (Table 7), and IOException (Table 4).

Method writeBytes writes the whole sequence to the stream. (Blocking call.) Method flush flushes any data that may exist in buffers out of the stream. Method closeOutput is called to indicate that all data has been written. If this method is not yet been called, no attached interface XInputStream receives an EOF signal. No further bytes may be written after this method has been called.

TABLE 12
INTERFACE XOutputStream

interface XOutputStream:

com::sun::star::uno::XInterface

{
void writeBytes( [in] sequence<byte> aData )

raises( com::sun::star::io::NotConnectedException,
com::sun::star::io::BufferSizeExceededException,

com::sun::star::io::IOException);

void flush()

raises ( com::sun::star::io::NotConnectedException,
com::sun::star::io::BufferSizeExceededException,

com::sun::star::io::IOException);

void closeOutput ()

raises ( com::sun::star::io::NotConnectedException,
com::sun::star::io::BufferSizeExceededException,

com::sun::star::io::IOException);

};

Interface XActiveDataSource (Table 13) inherits from interface XInterface that is presented in Table 2. In this embodiment, interface XActiveDataSource includes method setOutputStream and method getOutputStream. Method setOutputStream plugs the output stream, while method getOutputStream returns the plugged stream.

TABLE 13
INTERFACE XActiveDataSource

interface XActiveDataSource:

com::sun::star::uno::XInterface

void setOutputStream( [in]

com::sun::star::io::XOutputStream aStream );

com::sun::star::io::XOutputStream getOutputStream();
};

Herein, a computer program product comprises a medium configured to store or transport computer readable code for all or any part of filter server 120 and in particular in which computer readable code for conversion service 125 is stored. Some examples of computer program products are CD-ROM discs, ROM cards, floppy discs, magnetic tapes, computer hard drives, servers on a network and signals transmitted over a network representing computer readable program code.

As illustrated in FIG. 1B, this storage medium may belong to computer system 102i itself. However, the storage medium also may be removed from computer system 102i. For example, conversion service 125 may be stored in memory 184 that is physically located in a location different from processor 101. The only requirement is that processor 101 is coupled to the memory. This could be accomplished in a client-server system, e.g. as in FIG. 1A, or alternatively via a connection to another computer via modems and analog lines, or digital interfaces and a digital carrier line.

Herein, a computer memory refers to a volatile memory, a non-volatile memory, or a combination of the two. Similarly, a computer input unit and a display unit refers to the features providing the required functionality to input the information described herein, and to display the information described herein, respectively, in any one of the aforementioned or equivalent devices.

In view of this disclosure, filter server 120 can be implemented in a wide variety of computer system configurations. In addition, filter server 120 could be stored as different modules in memories of different devices. For example, conversion service 125 could initially be stored in a server computer 100, and then as necessary, a module of conversion service 125 could be transferred to a client device 102i and executed on client device 102i. Consequently, part of conversion service 125 would be executed on the server processor, and another part would be executed on the processor of client device 102i. In view of this disclosure, those of skill in the art can implement the invention in a wide-variety of physical hardware configurations using an operating system and computer programming language of interest to the user.

Filter server 120 of the present invention may be implemented in a computer program including comprehensive office application STAROFFICE that is available from Sun Microsystems, Inc. of Palo Alto, Calif. (STAROFFICE is a trademark of Sun Microsystems.) Such a computer program may be stored on any common data carrier like, for example, a floppy disc or a compact disc (CD), as well as on any common computer system's storage facilities like hard discs. Therefore, one embodiment of the present invention also relates to a data carrier for storing a computer program for carrying out the inventive method. Another embodiment of the present invention also relates to a method for using a computer system for carrying out the presented inventive method. In yet another embodiment of the present invention further a computer system includes a storage medium on which a computer program for carrying out the presented inventive method is stored.

This application is related to commonly filed and commonly assigned U.S. patent application Ser. No. ______, entitled “A NETWORK PORTAL SYSTEM AND METHODS” of Matthias Hütsch, Ralf Hofmann and Kai Sommerfeld (Attorney Docket No. 4595), which is incorporated herein by reference in its entirety.

We claim:

1. A computer-based method comprising:
receiving a request for data;
retrieving, from a filter registry in response to said request, a rule set for a plurality of partial filter adapters wherein, upon being chained together said plurality of partial filter adapters converts source data to said data; and
building a filter using said rule set wherein said filter comprises a chain of said plurality of partial filter adapters wherein each partial filter adapter includes a generic format independent interface and said generic format independent interface is used in passing data from one partial filter adapter in said plurality of partial filter adapters to another partial filter adapter in said plurality of partial filter adapters.

2. A method according to claim 1 wherein said filter renders the source data in a different way to produce said data.

3. A method according to claim 1 wherein said filter converts said source data from a first format to a second format.

4. A method according to claim 3 wherein a device from which said request for data was issued supports at least two data formats, and said method further comprises:
selecting said second data format from said at least two data formats.

5. A method according to claim 4, wherein said selecting said second data format further comprises:
using a selection scheme including at least one of the following criterion: storage space required by said data in each of said two data formats supported by said process; conversion time for said data from said first data format into each of said data formats supported by said process; and a quality for each of said two data formats.

6. The method of claim 1 further comprising:
converting said source data to said data using said filter.

7. The method of claim 1 wherein said generic format independent interface is a Simple API for XML interface.

8. The method of claim 1 wherein said partial filter adapters comprise a general partial filter adapter having functionality determined by a parameter.

9. The method of claim 8 wherein said general partial filter adapter comprises an extensible Style sheet Language Transformation processor, and said parameter comprises an extensible Style sheet Language Transformation script.

10. A computer program product comprising a medium configured to store or transport computer readable code for a method comprising:
receiving a request for data;
retrieving, from a filter registry in response to said request, a rule set for a plurality of partial filter adapters wherein, upon being chained together said plurality of partial filter adapters converts source data to said data; and
building a filter using said rule set wherein said filter comprises a chain of said plurality of partial filter adapters wherein each partial filter adapter includes a generic format independent interface and said generic format independent interface is used in passing data from one partial filter adapter in said plurality of partial filter adapters to another partial filter adapter in said plurality of partial filter adapters.

11. A computer program product as in claim 10 wherein said filter renders the source data in a different way to produce said data.

12. A computer program product as in claim 10 wherein said filter converts said source data from a first format to a second format.

13. A computer-based method comprising:
receiving a request for data having a first format from a process requiring data in a second format;
retrieving, from a filter registry in response to said request, a rule set for a plurality of partial filter adapters wherein, upon being chained together said plurality of partial filter adapters converts said data from said first format to said second format; and
building a filter using said rule set wherein said filter comprises a chain of said plurality of partial filter adapters wherein each partial filter adapter includes a generic format independent interface and said generic format independent interface is used in passing data from one partial filter adapter in said plurality of partial filter adapters to another partial filter adapter in said plurality of partial filter adapters.

14. A method according to claim 13 further comprising:
selecting said second data format from at least two data formats supported by said process.

15. A method according to claim 14, wherein said selecting said second data format further comprises:
using a selection scheme including at least one of the following criterion: storage space required by said data in each of said two data formats supported by said process; conversion time for said data from said first data format into each of said data formats supported by said process; and a quality for each of said two data formats.

16. The method of claim 13 further comprising:
converting said data in said first format to data in said second format using said filter.

17. The method of claim 13 wherein said generic format independent interface is a Simple API for XML interface

18. The method of claim 13 wherein said partial filter adapters comprise a general partial filter adapter having functionality determined by a parameter.

19. The method of claim 18 wherein said general partial filter adapter comprises an extensible Style sheet Language Transformation processor, and said parameter comprises an extensible Style sheet Language Transformation script.

20. A structure comprising:
a partial filter adapter library;
a partial filter adapter registry wherein said partial filter adapter registry includes a rule set; and
a filter server coupled to said partial filter adapter registry and to said partial filter adapter library, wherein said filter server uses said rule set to build a filter using a plurality of partial filter adapters from said partial filter adapter library.

21. A structure comprising:
a first partial filter adapter having a generic format independent interface; and
a second partial filter adapter having said generic format independent interface coupled to said first partial filter adapter.

22. The structure of claim 21 wherein said generic format independent interface is a simple API for XML interface.

23. The structure of claim 22 wherein said simple API for XML interface is a XML document handler interface.

24. A method for rendering accessible data stored in a first data format in a first computer system for a second computer system supporting a second data format, said method comprising:
receiving in said first computer system a request from said second computer system for said data;
receiving in said first computer system information about at least one data format supported by said second computer system, selecting said second data format, if said first computer system was informed about more than one data format supported by said second computer system;
comparing in said first computer system said first data format with said second data format,
generating a filter for converting said data from said first data format into said second data format, if said first data format is incompatible with said second data format, by combining a first partial filter adapter to a second partial adapter for the transformation of data; and
converting said data in said first computer system using said filter from said first data format into said second data format.
